(19) United States
(12) Patent Application Publication
(10) Pub. No.: US 2009/0193327 A1
(43) Pub. Date: Jul. 30, 2009

(54) HIGH-FIDELITY SCALABLE ANNOTATIONS

(75) Inventors: Subrata Roychoudhuri, Hyderabad (IN); Ananta Subrahmanya Sarma Gudipaty, Kirkland, WA (US); Santosh Gangwani, Nizamabad (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/022,997

(22) Filed: Jan. 30, 2008

(51) Int. Cl. G06F 17/00

(52) U.S. Cl. 715/231

(57) ABSTRACT

Technologies are described herein for providing high-fidelity scalable annotations. Annotations made to meeting content during a hosted online meeting are recorded separately from the meeting content itself. At playback time, the annotations are rendered separately from the meeting content. Because the annotations are rendered separately from the meeting content at playback time, the annotations can be scaled without loss of clarity and visual effects can be applied to the annotations independently of the meeting content.

### BACKGROUND

Hosted World Wide Web (“Web”) conferencing services allow users to meet and collaborate over the Internet. In particular, users can upload documents to a server computer operated by the provider of the hosted conferencing service and share the documents among the meeting participants. Users can also annotate the documents as they are presented, such as by using a tablet-based computer to write notes or other comments on the shared documents or on a whiteboard. Hosted conferencing services also typically provide functionality for making a recording of a hosted meeting. This often includes generating an audio/video recording of the presented documents and the annotations as they are being presented. The audio/video recording is then saved so that meeting participants or others may view the meeting at a later time.

Current implementations for making a recording of a hosted meeting capture all presented documents and annotations as a single audio/video file. For instance, in some implementations, a single audio/video file is generated that includes all of the presented documents, audio data, and annotations. The single audio/video file may then be played back at a later time to view the meeting. Recording a hosted meeting in this manner composites the presented documents and annotations at record time into a single audio/video recording, which can be easily stored by the conferencing service and made available for viewing at a later time.

While recording a single audio/video file that includes meeting documents and annotations to a single file does allow for ease of recording and playback, recording a hosted meeting in this manner does have its drawbacks. For instance, if a single audio/video file recorded in the manner described above is resized at playback time, any recorded annotations in the audio/video file will lose a great deal of clarity and may become distorted or even incomprehensible. Because the annotations are recorded into a single audio/video file with the other meeting content, it is also not possible to perform visual effects on the annotations alone at the time of playback.

It is with respect to these considerations and others that the disclosure made herein is presented.

### SUMMARY

Technologies are described herein for providing high-fidelity scalable annotations. In particular, through the implementation of the technologies and concepts presented herein, annotations made to meeting content during a hosted online meeting are recorded separately from the meeting content itself. At playback time, the annotations are rendered separately from the meeting content, thereby allowing the annotations to be played back with a higher level of visual detail than permitted by previous solutions. Moreover, because the annotations are rendered as vector data separately from the meeting content at playback time, the annotations can be scaled without loss of clarity and visual effects can be applied to the annotations independently of the meeting content.

According to one aspect presented herein, a hosted conferencing server computer is disclosed that is configured to provide functionality for collaborating over a network, such as the Internet. In particular, the hosted conferencing server computer provides functionality for hosting an online meeting. Meeting participants can upload meeting content, like documents, to the hosted conferencing server computer and share the meeting content among the meeting participants. Meeting participants can also make annotations on the meeting content, such as for instance writing a note on a shared document using a tablet-based computer.

The hosted conferencing server computer also provides features for recording and playing back a hosted online meeting. In one implementation, the hosted conferencing server creates a recording of a hosted online meeting by capturing events that occur during the meeting along with a timestamp and space coordinates. The server also captures meeting content presented during the hosted meeting in its native format. The hosted conferencing server also captures annotations made to the meeting content or a whiteboard by generating data defining the annotations. The server captures meta-data describing the annotations, along with a timestamp indicating the time at which the annotations were made and their space coordinates in the meeting. The annotations are captured once and any modifications to the annotations, like resizing, moving or editing, are captured as changes to the original annotation along with data identifying the time of the change. In embodiments, the hosted conferencing server generates data defining the annotations in a vector format, such as the vector markup language (“VML”) format or the scalable vector graphics (“SVG”) format. The meeting content is stored separately from the data defining the annotations made to the meeting content.

According to other aspects, the hosted conferencing server computer also provides functionality for playing back a recording of a hosted online meeting in conjunction with a conferencing client application executing on a client computer. In one implementation, a rendering is generated of the meeting content using native player applications configured to render the meeting content. A rendering is separately made of the annotations to the meeting content by rendering the data defining the one or more annotations to the meeting content.

Once the rendering of the meeting content and the rendering of the annotations have been generated, the conferencing client can play back the recording of the meeting by displaying the renderings in the time sequence in which they occurred during the meeting. In one implementation, the rendering of the annotations is displayed on a transparent layer that is presented over the rendering of the meeting content. Because the annotations are rendered separately from the meeting content at playback time, the annotations can be scaled independently from the meeting content to maintain a high level of visual quality. Moreover, because the annotations are rendered on a transparent layer at playback time, visual effects can be applied to the annotations separately from the rendering of the meeting content. For instance, the annotations can be faded out after a period of time.

It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components provided by the embodiments presented herein;

FIG. 2 is a software architecture diagram showing aspects of a conferencing server computer provided in one embodiment described herein;

FIG. 3 is a screen diagram showing an illustrative screen display provided by a conferencing client in one embodiment presented herein;

FIG. 4 is a flow diagram showing an illustrative process for creating a recording of a hosted online meeting in one embodiment;

FIG. 5 is a software architecture diagram showing additional aspects of a conferencing server computer provided in one embodiment described herein;

FIG. 6 is a flow diagram showing an illustrative process for playing back a recording of a hosted online meeting in one implementation;

FIG. 7 is a perspective diagram showing aspects of one process for rendering annotations at playback time in an implementation provided herein; and

FIG. 8 is a computer architecture diagram showing an illustrative computer hardware and software architecture for a computing system capable of implementing aspects of the embodiments presented herein.

### DETAILED DESCRIPTION

The following detailed description is directed to technologies for providing high-fidelity scalable annotations. Through the use of the technologies and concepts presented herein, annotations made during a hosted online meeting are recorded and stored separately from other meeting content. At playback time, the annotations are rendered separately from the meeting content, thereby permitting high-fidelity resealing of the annotations and the application of visual effects to the annotations.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing high-fidelity annotations will be described.

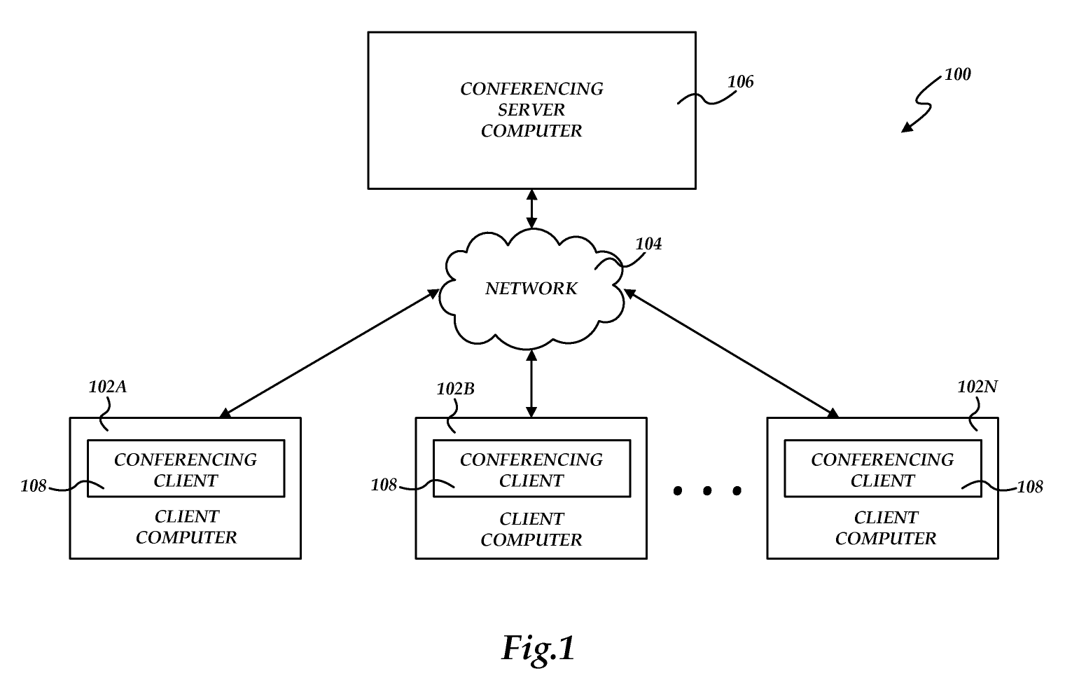

Turning now to FIG. 1, details will be provided regarding an illustrative operating environment and several software components provided by the embodiments presented herein. In particular, FIG. 1 illustrates aspects of a hosted conferencing service 100. The hosted conferencing service 100 provides an operating environment for the particular embodiments presented herein. The hosted conferencing service 100 illustrated in FIG. 1 includes several client computers 102A-102N connected to a conferencing server computer 106 via a network 104. Each of the client computers 102A-102N comprises a standard desktop or laptop computer capable of executing an operating system and a conferencing client 108. Together, the conferencing client 108 and the conferencing server computer 106 provide facilities for allowing users of the client computers 102A-102N to participate in an online hosted conference (also referred to herein as a “meeting”).

According to various embodiments, the conferencing server computer 106 is configured to execute software components for allowing the users of the client computers 102A-102N to meet and collaborate in a shared virtual workspace. In particular, a user may be permitted to upload documents to the conferencing server computer 106 and to share the documents among the operators of the client computers 102A-102N. Additional functionality may be provided for allowing the users to add annotations to content presented during a meeting. For instance, a user may be permitted to annotate meeting content with words, shapes, or other markings using an appropriate input device, such as a keyboard, mouse, stylus, or touch screen display. As will be described in greater detail below, the conferencing server computer 106 and the conferencing client 108 also provide functionality for recording and playing back meetings, including the recording and playing back of annotations made during a meeting with a high level of visual quality, or fidelity.

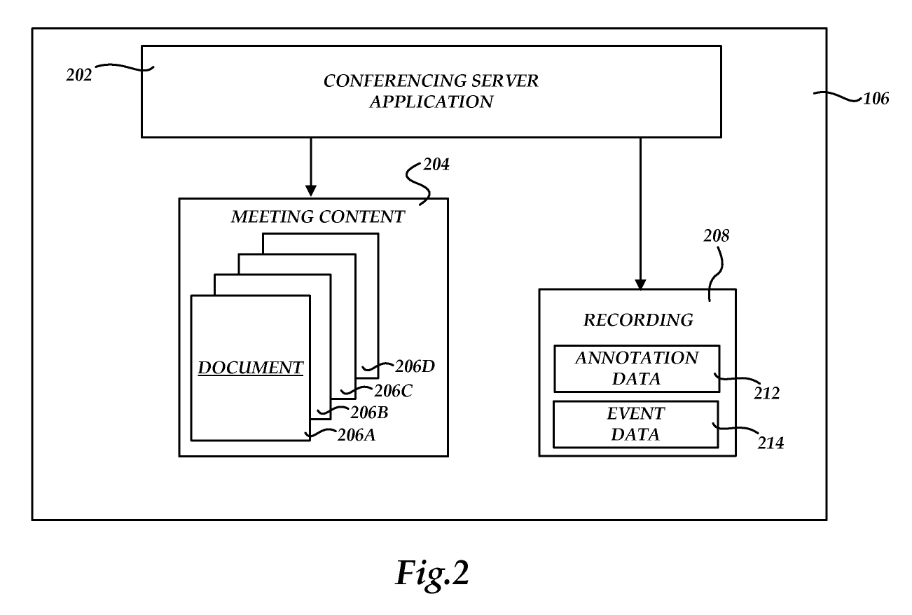

As mentioned briefly above, the conferencing server computer 106 provides functionality for making a recording of a hosted meeting. Rather than recording a single audio/video file of the meeting, the conferencing server computer 106 stores data that defines all of the events and actions that take place during a meeting. Each event is also given a timestamp relative to the start of the recording indicating when the event took place. The conferencing server computer 106 also stores content presented during the meeting, such as a document, in its native format. Vector data defining any annotations made to the meeting content is also generated and stored in a vector format. Using the event data, the timestamps, the captured meeting content, and the vector data, the meeting can be recreated at playback time in exactly the same manner as it originally took place. Additional details regarding this process are provided below with respect to FIGS. 2-8.

Referring now to FIG. 2, additional details regarding the operation of the conferencing server computer 106 will be provided. In particular, FIG. 2 is a software architecture diagram showing aspects of some of the software components utilized by the conferencing server computer 106. In this regard, the conferencing server computer 106 executes the conferencing server application 202. The conferencing server application 202 controls all aspects of the operation of the conferencing server computer 106 with respect to the provision of online hosted conferences, including communicating with the conferencing clients 108A-108N executing on each of the client computers 102A-102N, respectively.

As discussed above with respect to FIG. 1, the conferencing server application 202 provides functionality for allowing users to engage in an online hosted conference, including the presentation of meeting content 204, making annotations to the meeting content, 204 creating a recording 208 of the conference, and playing back the recording 208. As also discussed briefly above with respect to FIG. 1, the conferencing server computer 106 stores meeting content 204 for each meeting that is hosted by the conferencing server computer 106. For instance, as shown in FIG. 2, the meeting content 204 for a particular meeting may include meeting documents 206A-206D. It should be appreciated that the meeting content 204 is stored on a per-meeting basis. As a result, therefore, meeting content for other meetings may be stored in a similar manner by the conferencing server computer 106.

It should also be appreciated that the operators of the client computers 102A-102N generally provide the documents 206A-206D. For instance, an operator of the client computer 102A may desire to present a word processing document to the other meeting participants. In this regard, the conferencing client 108 provides functionality for allowing a user of the client computer 102A to submit the word processing document to the conferencing server computer 106 for presentation to the other meeting participants. Virtually any other type of document may also be submitted to the conferencing server computer 106 for presentation during a hosted meeting. For instance, spreadsheet documents, presentation documents, graphical image files, and other types of documents may be submitted to the conferencing server computer 106 for presentation during a hosted meeting. The term “meeting content” as used herein, therefore, refers to any content that is presented during an online hosted conference.

As will be discussed in greater detail below, the conferencing server application 202 is also operative to provide functionality for creating a recording 208 of a hosted conference and to permit the playback of the recording 208. In order to create the recording 208 of a hosted online conference, the conferencing server application 202 captures all of the meeting content 204 that is presented during a meeting in its native format. For instance, if the document 206A is a word processing document that is presented during a meeting, the conferencing server application 202 will capture and store the document 206A in its native word processing format. As will be discussed in greater detail below, capturing meeting content 204 in its native format allows the meeting content 204 to be played back at a later time using a native player application program capable of rendering the meeting content 204.

In order to create the recording 208 of a hosted online conference, the conferencing server application 202 also captures all of the events and actions that take place during a meeting. In particular, the conferencing server application 202 stores event data 214 that identifies all of the actions and events that take place during a meeting. For instance, if a user presents a document 206A during a meeting, event data 214 is generated that identifies the document 206A that was presented and the manner in which it was presented. The event data 214 also includes timestamp data for each of the recorded events indicating a time at which the event took place relative to the start of the meeting. The conferencing server application 202 utilizes the timestamp data to play back the recorded events in the same sequence that they took place during the original meeting. The coordinates of the annotation are also captured along with the annotation. A z-coordinate is also specified for the annotations that is above the z-coordinate of the document or whiteboard that is being annotated. In this manner the annotations are displayed on top of the document or whiteboard at playback time. Moreover, in embodiments, documents and annotations are captured once and any changes are captured as incremental modifications to the original along with a timestamp indicating the time of the change. For a free drawing annotation, a small interval is specified and whatever is drawn within the interval is considered an annotation. Further free drawing is captured as changes to the original drawing.

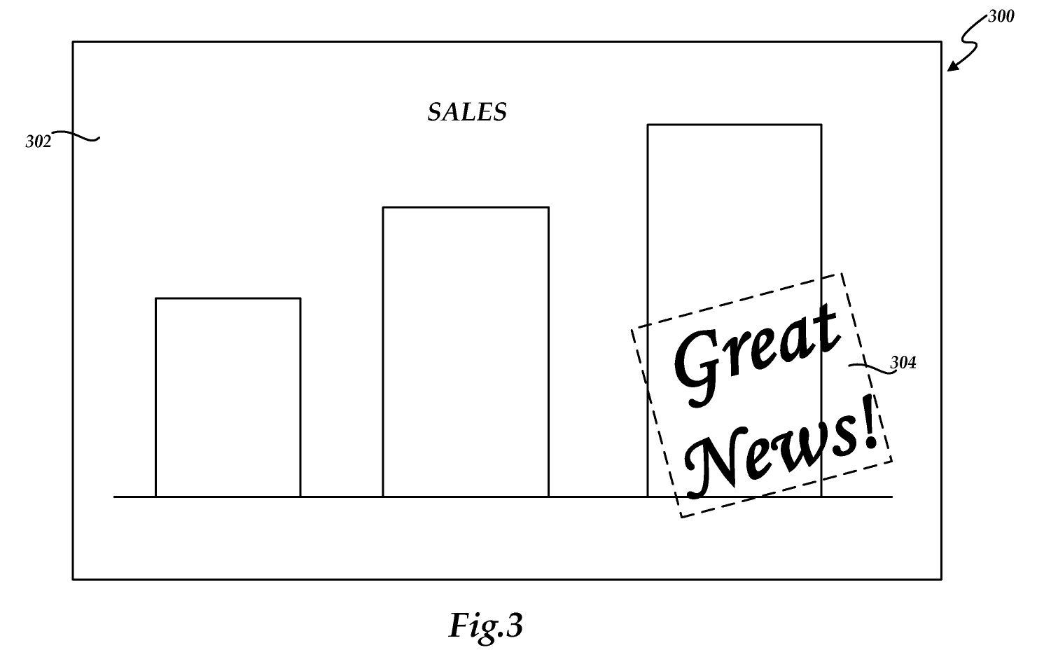

In order to record annotations to meeting content 204 that are made during an online hosted conference, the conferencing server application 202 stores annotation data 212. The annotation data 212 defines the annotations that are made during a meeting and are utilized at playback time to recreate the annotations. According to embodiments, the conferencing server application 202 generates vector data that defines the annotations and stores the vector data in a vector format. For instance, in one implementation, the conferencing server application 202 stores the annotation data 212 in the Vector Markup Language (“VML”) format. In another implementation, the conferencing server application 202 stores the annotation data 212 in the Scalable Vector Graphics (“SVG”) format. Other formats may also be utilized. In one embodiment, vector data is generated at the time of the meeting that defines the annotations in a proprietary format. The proprietary vector data is then converted to a standard vector format at a later time. Timestamps may also be utilized with the annotation data 212 to recreate the annotations at playback time in the same manner they were made during the original meeting. Additional details regarding the recording and play back of annotations made to meeting content 204 during an online hosted conference are provided below with respect to FIGS. 3-7.

Turning now to FIG. 3, additional details will be provided regarding one process for annotating the meeting content 204. As discussed briefly above, the conferencing client 108 provides functionality for allowing a user of a client computer 102A-102N to annotate meeting content 204 presented during an online hosted conference. A screen display 300 provided by the conferencing client 108 is shown in FIG. 3 that illustrates this process further. In particular, the screen display 300 includes a rendering 302 of a document 206A generated by the conferencing client 108. As discussed above, a user may upload a document 206A to the conferencing server application 202 for presentation to users of the client computers 102A-102N through the conferencing client 108.

In addition to providing the rendering 302 of the document 206A, the conferencing client 108 is also operative to allow users of the client computers 102A-102N to annotate the rendering 302 of the document 206A. For instance, a user of one of the client computers 102A-102N may utilize a keyboard, stylus, or other input device to add text or other types of annotations to the rendering 302 of the document 206A. In the example illustrated in the screen display 300, a user has added the annotation 304 to the rendering 302. In this example, the annotation 304 includes text that has been applied on top of the rendering 302. It should be appreciated however, that other types of annotations may be made in a similar manner (e.g. multi-colored text, lines, highlighter, pointing indications, and various shapes). As will be described in greater detail below, the embodiments presented herein provide technologies for rendering the annotation 304 at playback time in a manner that results in a high-fidelity display and that allows visual effects to be applied to the annotation 304. Moreover, the embodiments presented herein provide a higher fidelity recording since source documents are not converted to video, provides a smaller file size than previous solutions, and requires less processing.

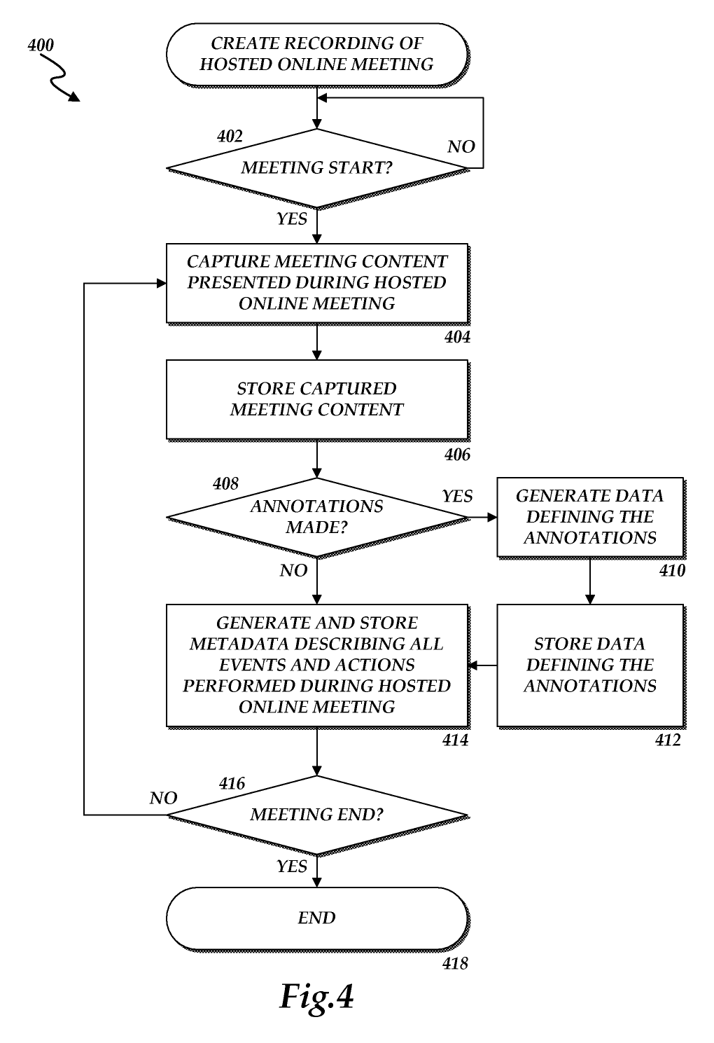

Referring now to FIG. 4, additional details will be provided regarding the embodiments presented herein for providing high-fidelity scalable annotations. In particular, FIG. 4 is a flow diagram illustrating aspects of the operation of the conferencing server computer 106 for recording a hosted online conference. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 400 begins at operation 402, where the conferencing server application 202 determines whether an online hosted conference has started. If a conference has not started, the routine 400 proceeds back to operation 402. If it is determined, however, that an online hosted conference has started, the routine 400 continues to operation 404. At operation 404, the conferencing server application 202 captures meeting content 204 that is presented during the online hosted conference. For instance, as illustrated in FIG. 2 and described above, the conferencing server application 202 may capture the documents 206A-206D and store them in their native format. The conferencing server application 202 stores the meeting content 204 at operation 406.

From operation 406, the routine 400 continues to operation 408 where the conferencing server application 202 determines whether a user of one of the client computers 102A-102N has made an annotation 304. If an annotation 304 has been made, the routine 400 branches to operation 410 where the conferencing server application 202 generates the annotation data 212. As described above, the annotation data 212 defines the annotations made to the meeting content 204 during the online hosted conference. The annotation data 212 may comprise vector data stored in a vector format. Once the vector data has been generated, the routine 400 continues from operation 410 to operation 412 where the annotation data 212 is stored by the conferencing server application 202.

If, at operation 408, the conferencing server application 202 determines that no annotations have been made, the routine 400 continues to operation 414. The routine 400 also continues to operation 414 from operation 412, described above. At operation 414, the conferencing server application 202 generates the event data 214. As described above, the event data 214 comprises metadata that describes all of the events and actions performed during the online hosted conference. In this manner, the conferencing server application 202 stores and records the meeting content 204 presented during the meeting, annotations made to the meeting content 204 during the meeting, and metadata sufficient to recreate the events and actions that took place during the meeting at playback time.

From operation 414, the routine 400 continues to operation 416 where the conferencing server application 202 determines whether the meeting has ended. If the meeting has not ended, the routine 400 proceeds to operation 404 described above. In this manner, the conferencing server application 202 continuously records the meeting content 204, annotations 304, and actions and events performed during a meeting. If the meeting has ended, the routine 400 continues from operation 416 to operation 418 where it ends.

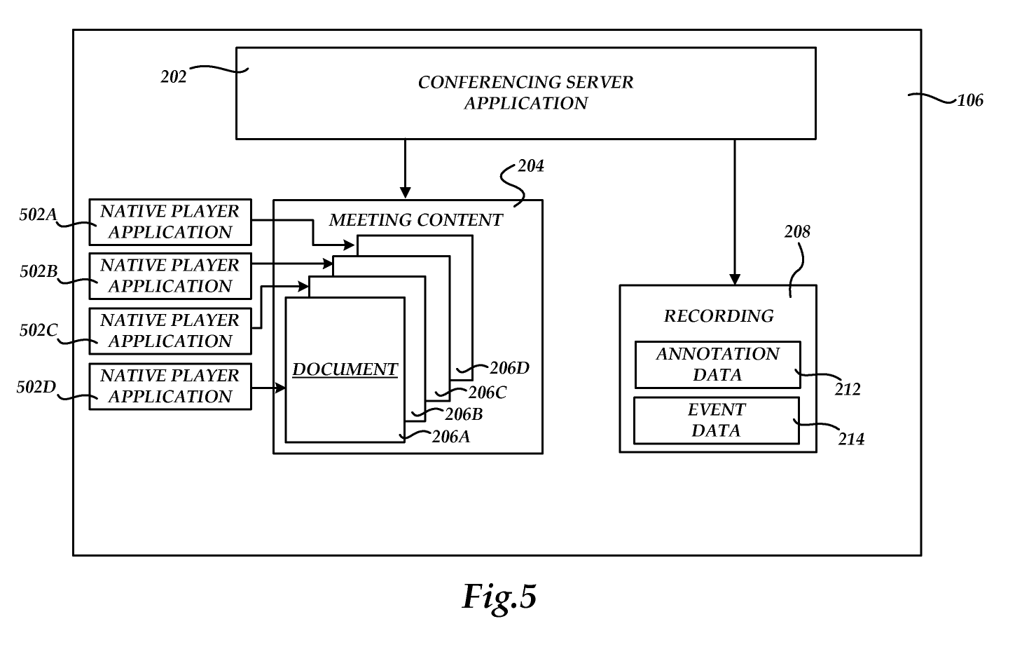

Referring now to FIG. 5, additional details will be provided regarding the playback of the recording 208 made by the conferencing server application 202. As discussed briefly above, once the recording 208 has been made and stored at the conferencing server application 202, a user of one of the client computers 102A-102N may request playback of the recording 208. In general, the recording 208 is played back by utilizing the event data 214 to recreate the events and actions that took place during the online hosted conference in the same order and at the same speed at which they originally took place. The event data, including the time stamps, are utilized to recreate all of the events.

In particular, the meeting content 204 stored by the conferencing server application 202 is utilized to recreate the documents 206A-206D that were presented during the online hosted conference. In order to render the documents 206A-206D at playback time, one or more native player applications 502A-502D may be utilized. Each of the native player applications 502A-502D is configured to render documents of a particular document type. For instance, if a document 206A comprises a word processing document, the native player application 502D comprises an application configured to render word processing documents of the particular document type. Other compatible universal rendering programs may also be utilized. For instance, a web browser application program may be utilized in one embodiment.

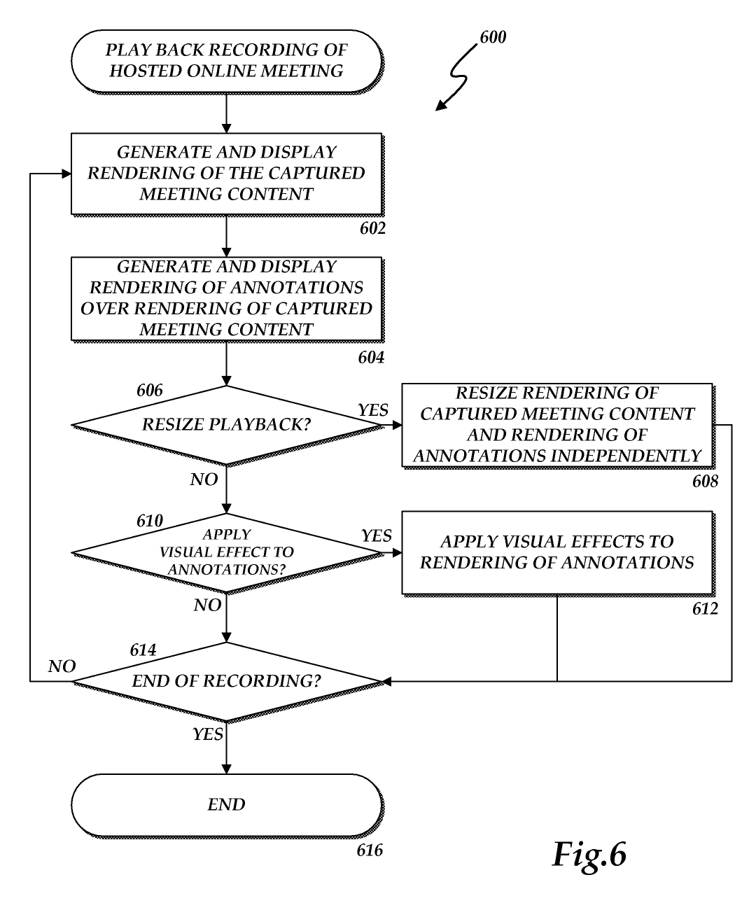

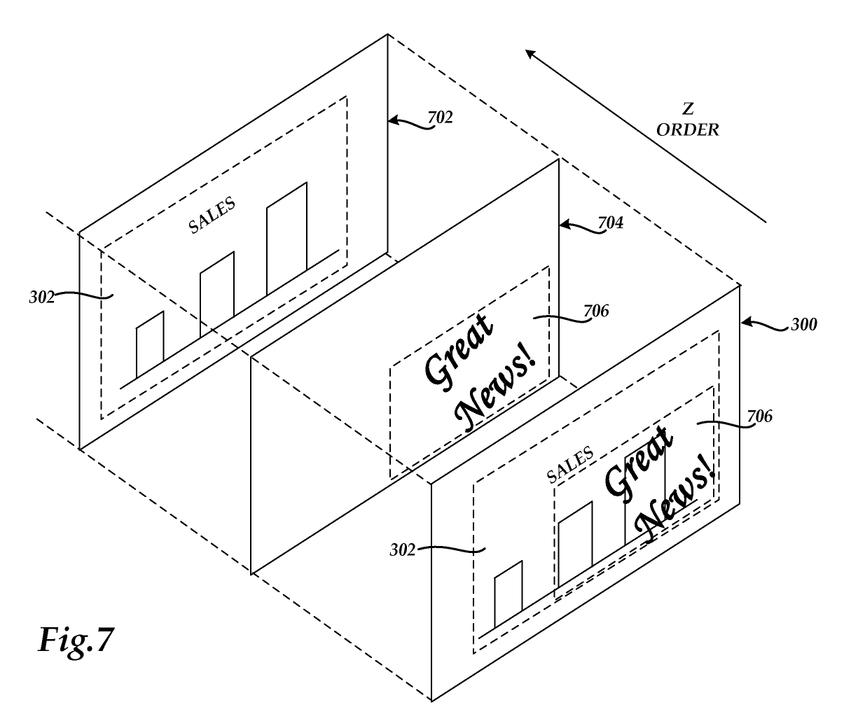

In order to recreate any annotations 304 made during the online hosted conference, the conferencing server application 202 utilizes the annotation data 212. In particular, the vector data contained in the annotation data 212 is rendered by the conferencing server application 202 to recreate the annotations in the manner in which they were made during the online hosted conference. As will be discussed in greater detail with respect to FIGS. 6 and 7, the annotation data 212 is rendered separately from the meeting content 204. This allows the annotations 304 made during the online hosted conference to be scaled independently of the meeting content 204. This also allows the annotations 304 to be manipulated independently of the meeting content 204, including the application of visual effects to the annotations 304 as they are rendered. Additional details regarding this process are provided below with respect to FIGS. 6 and 7.

Turning now to FIG. 6, an illustrative routine 600 will be described for playing back a recording 208 made by the conferencing server application 202 of an online hosted conference. The routine 600 begins at operation 602, where the conferencing server application 202 generates and displays the rendering 302 of the captured meeting content 204. As discussed above, the native player applications 502A-502D may be utilized by the conferencing application 202 to generate the rendering 302 of the presented documents. From operation 602, the routine 600 continues to operation 604, where the conferencing server application 202 renders the annotation data 212 to recreate any annotations 304 made during the original online hosted conference. As will also be described in greater detail below with respect to FIG. 7, the annotation data 212 is rendered separately from the meeting content 204 and displayed on a transparent visible layer (frequently referred to as “glass”) above the rendering of the meeting content 204. As will be described in greater detail below, rendering the annotations 304 on a separate layer from the meeting content 204 allows the annotations 304 to be resized independently of the meeting content 204 and allows visual effects to be applied to the annotations 304 independently of the meeting content 204.

From operation 604, the routine 600 continues to operation 606 where a determination is made as to whether a user of one of the client computers 102A-102N has requested that the size of a user interface window containing the playback of the recording 208 be resized. If so, the routine 600 branches from operation 606 to operation 608 where the rendering 302 of the meeting content 204 is resized. The rendering of the annotation data 212 is also resized at operation 608, but independently of the resizing of the rendering 302 of the meeting content 204. Because the annotation data 212 is expressed using vector data and resized independently of the rendering 302 of the meeting content 204, the annotation data 212 retains a high degree of visual fidelity following the resizing operation. Once the resizing has completed, the routine 600 continues from operation 608 to operation 614.

If, at operation 606, the conferencing server application 202 determines that a request to resize playback has not been received, the routine 600 continues from operation 606 to operation 610. At operation 610, the conferencing server application 202 determines whether a visual effect should be applied to the annotations as they are rendered. For instance, according to one implementation, a fade-out visual effect may be applied to the annotations as they are rendered. The fade-out visual effect causes the annotations to be removed from display after a pre-determined period of time. If a visual effect, such as the fade-out visual effect, is to be applied to the annotations, the routine 600 branches from operation 610 to operation 612. At operation 612, the specified visual effect is applied to the rendering of the annotation data 212. As discussed above, this is possible because the annotation data 212 is rendered separately from the meeting content 204.

From operation 612, the routine 600 continues to operation 614, where the conferencing server application 202 determines whether the end of the recording 208 has been reached. If not, the routine 600 returns to operation 602 described above where the conferencing server application 202 continues to render the meeting content 204 and the annotation data 212. If the end of the recording 208 has been reached, the routine 600 continues from operation 614 to operation 616, where it ends.

Referring now to FIG. 7, additional details will be provided regarding the process for playing back the recording 208 described above with reference to FIG. 6. In particular, FIG. 7 is a perspective diagram showing a translucent visible layer 702 onto which the rendering 302 is placed. A transparent visible layer 704 is utilized to display the rendering 706 of an annotation 304. The transparent visible layer 704 is placed in front of the translucent visible layer 702 in Z-order so that the rendering 706 of the annotation 304 appears in front of, or above, the rendering 302.

As discussed above with reference to FIG. 6, when the rendering 302 of the meeting content 204 is scaled on the translucent visible layer 702, the rendering 706 of the annotation 304 is appropriately scaled on the transparent visible layer 704. Moreover, because the rendering 706 of the annotation 304 is displayed in its own visible layer, the rendering 706 of the annotation 304 can be resealed and visual effects can be applied to rendering 706 independently of the contents of the translucent visible layer 702. In this manner, a screen display 300 is generated that includes a composite of the translucent visible layer 702 and the transparent visible layer 704.

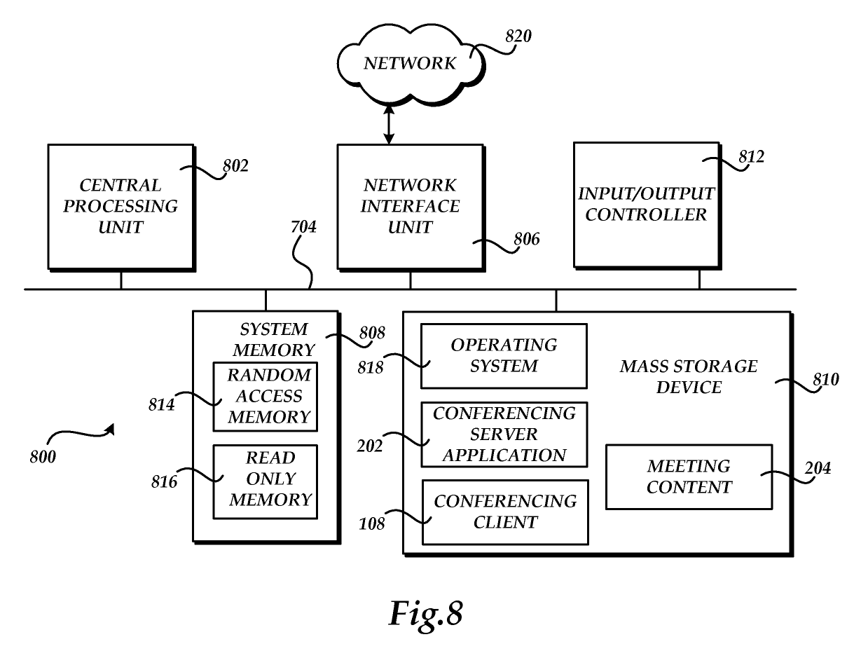

FIG. 8 shows an illustrative computer architecture for a computer 800 capable of executing the software components described herein for relevance-based expiration of data in the manner presented above. The computer architecture shown in FIG. 8 illustrates a conventional desktop, laptop, or server computer and may be utilized to execute any aspects of the software components presented herein described as executing on the conferencing server computer 106 or the client computers 102A-102N.

The computer architecture shown in FIG. 8 includes a central processing unit 802 (“CPU”), a system memory 808, including a random access memory 814 (“RAM”) and a read-only memory (“ROM”) 816, and a system bus 804 that couples the memory to the CPU 802. A basic input/output system containing the basic routines that help to transfer information between elements within the computer 800, such as during startup, is stored in the ROM 816. The computer 800 further includes a mass storage device 810 for storing an operating system 818, application programs, and other program modules, which are described in greater detail herein.

The mass storage device 810 is connected to the CPU 802 through a mass storage controller (not shown) connected to the bus 804. The mass storage device 810 and its associated computer-readable media provide non-volatile storage for the computer 800. Although the description of computer-readable media contained herein refers to a mass storage device, such as a hard disk or CD-ROM drive, it should be appreciated by those skilled in the art that computer-readable media can be any available computer storage media that can be accessed by the computer 800.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800.

According to various embodiments, the computer 800 may operate in a networked environment using logical connections to remote computers through a network such as the network 820. The computer 800 may connect to the network 820 through a network interface unit 806 connected to the bus 804. It should be appreciated that the network interface unit 806 may also be utilized to connect to other types of networks and remote computer systems. The computer 800 may also include an input/output controller 812 for receiving and processing input from a number of other devices, including a keyboard, mouse, or electronic stylus (not shown in FIG. 8). Similarly, an input/output controller may provide output to a display screen, a printer, or other type of output device (also not shown in FIG. 8).

As mentioned briefly above, a number of program modules and data files may be stored in the mass storage device 810 and RAM 814 of the computer 800, including an operating system 818 suitable for controlling the operation of a networked desktop, laptop, or server computer. The mass storage device 810 and RAM 814 may also store one or more program modules. In particular, the mass storage device 810 and the RAM 814 may store the conferencing server application 202, the conferencing client 108, and the meeting content 204, each of which was described in detail above with respect to FIGS. 1-7. The mass storage device 810 and the RAM 814 may also store other types of program modules.

Based on the foregoing, it should be appreciated that technologies for providing high-fidelity scalable annotations are provided herein. It should be appreciated that in one embodiment, the meeting content comprises a whiteboard. In this embodiment, the annotations are presented over a solid colored background. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing high-fidelity annotations during playback of a recording of a hosted online meeting, the method comprising:
creating the recording of the hosted online meeting by capturing meeting content presented during the hosted online meeting, generating data defining one or more annotations made to the meeting content during the hosted online meeting, and storing the captured meeting content separately from the data defining the one or more annotations made to the meeting content; and
playing back the recording of the hosted online meeting by generating a rendering of the captured meeting content, generating a rendering of the annotations made to the meeting content by rendering the data defining the one or more annotations made to the meeting content separately from the rendering of the captured meeting content, and displaying the rendering of the annotations with the rendering of the captured meeting content.

2. The method of claim 1, wherein playing back the recording of the hosted online meeting further comprises displaying the rendering of the captured meeting content on a first visible layer and displaying the rendering of the annotations on a second visible layer, and wherein the second visible layer is a transparent layer displayed over the first visible layer.

3. The method of claim 1, wherein generating data defining one or more annotations made to the meeting content comprises capturing an annotation and a change to the annotation along with a timestamp indicating a time at which the change was made.

4. The method of claim 1, wherein the meeting content comprises a whiteboard.

5. The method of claim 1, wherein generating data defining one or more annotations comprises recording a z-coordinate value for the annotations that is greater than a z-coordinate value for the meeting content.

6. The method of claim 2, further comprising:
receiving a request to resize the rendering of the captured meeting content; and
in response to receiving the request, resizing the rendering of the captured meeting content and resizing the rendering of the annotations independently of the resizing of the captured meeting content.

7. The method of claim 2, wherein generating a rendering of the captured meeting content comprises executing a native player application to generate the rendering of the captured meeting content on the first visible layer.

8. The method of claim 2, wherein generating a rendering of the annotations made to the meeting content further comprises applying a visual effect to the rendering of the annotations made to the meeting content.

9. The method of claim 2, wherein generating data defining one or more annotations made to the meeting content during the hosted online meeting comprises:
receiving the annotations; and
generating the data defining the annotations in a vector format based on the received annotations.

10. The method of claim 6, wherein the vector format comprise a vector markup language (VML) format.

11. A computer-readable medium having computer-executable instructions stored thereon which, when executed by a computer, cause the computer to:
capture meeting content presented during a hosted online meeting;
identify one or more annotations made to the meeting content during the hosted online meeting;
generate vector data defining the one or more annotations made to the meeting content during the hosted online meeting;
store the captured meeting content and the vector data defining the one or more annotations separately as a recording of the hosted online meeting;
receive a request to play back the recording of the hosted online meeting; and
in response to receiving the request, to generate a rendering of the meeting content presented during the hosted online meeting, to separately generate a rendering of the vector data defining the one or more annotations, and to cause a conferencing client application to display the rendering of the captured meeting content with the rendering of the vector data defining the one or more annotations.

12. The computer-readable medium of claim 11, wherein displaying the rendering of the captured meeting content with the rendering of the vector data defining the one or more annotations comprises displaying the rendering of the captured meeting content on a first visible layer and displaying the rendering of the vector data defining the one or more annotations on a second visible layer, and wherein the second visible layer is a transparent layer displayed over the first visible layer.

13. The computer-readable medium of claim 12, wherein generating a rendering of the meeting content presented during the hosted online meeting comprises executing one or more native player applications to generate the rendering of the meeting content presented during the hosted online meeting.

14. The computer-readable medium of claim 12, wherein generating a rendering of the vector data defining the one or more annotations further comprises applying a visual effect to the rendering of the vector data defining the one or more annotations.

15. The computer-readable medium of claim 12, having further computer-executable instructions stored thereon which, when executed by a computer, cause the computer to:
receive a request to resize the rendering of the captured meeting content; and
in response to receiving the request to resize, resizing the rendering of the captured meeting content and independently resizing the rendering of the vector data defining the one or more annotations made to the meeting content during the hosted online meeting.

16. The computer-readable medium of claim 12, wherein the vector data comprises data in a vector markup language format (VML).

17. The computer-readable medium of claim 12, wherein the vector data comprises data in a scalable vector graphics (SVG) format.

18. The computer-readable medium of claim 13, wherein the native player application comprises an application configured to create and edit the meeting content.

19. The computer-readable medium of claim 14, wherein the visual effect comprises a fade-out visual effect.

20. A method for providing high-fidelity annotations during playback of a recording of a hosted online meeting, the method comprising:
creating a recording of the hosted online meeting at a conferencing server computer by capturing meeting content presented during the hosted online meeting in a native format, capturing annotations made to the meeting content during the hosted online meeting by generating data in a vector format that defines the annotations, storing the captured meeting content in the native format, and storing the captured annotations separately from the captured meeting content; and
playing back the recording of the hosted online meeting by generating a rendering of the captured meeting content, generating a rendering of the data in the vector format that defines the annotations separately from the rendering of the captured meeting content, causing the rendering of the captured meeting content to be displayed by a conferencing client on a translucent visible layer, causing the rendering of the data in the vector format that defines the annotations to be displayed by the conferencing client on a transparent visible layer displayed in front of the translucent visible layer, and scaling or applying visual effects to the transparent layer independently of the translucent layer.
